(19) United States
(12) Patent Application Publication
(10) Pub. No.: US 2011/0068245 A1
(43) Pub. Date: Mar. 24, 2011

(54) ADJUSTABLE AND COLLAPSIBLE ONE-PIECE DISPLAY EASEL

(76) Inventors: Donald Scott Livingston, Fremont, CA (US); Garret Michael Moore, Fremont, CA (US)

(21) Appl. No.: 12/889,434

(22) Filed: Sep. 24, 2010

Related U.S. Application Data
(60) Provisional application No. 61/277,433, filed on Sep. 24, 2009.

(51) Int. Cl. A47B 97/04; B23P 11/00; B23P 23/00

(52) U.S. Cl. 248/460; 248/441.1; 29/428; 29/401.1

(57) ABSTRACT

An easel for holding objects such as smartphones, cell phones, business cards, recipes, and calendars. The profile of the easel resembles an asymmetric horizontal figure eight curve. The base of a display object rests on the top inside portion of the shelf or small loop of the figure eight curve and the back of the display object rests against the backrest or top inside portion of the large loop of the figure eight curve. The top of the shelf and the backrest are concave shaped to accommodate objects, such as smartphones, that have a curved base or curved back. The angle of the backrest may be adjusted to change the viewing angle of the display object. The easel is easily collapsible without any disassembly. The easel may be made from a single thin strip of material making it inexpensive to produce. The material can be recyclable.

### RELATED APPLICATIONS

The present application is related to U.S. Provisional application No. 61/277,433, filed and claiming the priority date of Sep. 24, 2009, for ADJUSTABLE AND COLLAPSIBLE ONE-PIECE DISPLAY EASEL included by reference herein.

### BACKGROUND OF THE INVENTION

This invention relates to easels for holding and displaying objects such as smartphones, cell phones, cameras, business cards, recipe cards, books and calendars.

There have been numerous designs for display easels proposed. Some of these designs incorporate an opening in the front of the easel in which the object being displayed is placed. U.S. Pat. No. 7,270,435 to Lin and U.S. Pat. No. 6,648,293 to Sachnoff have an opening. This type of design doesn't permit objects of varying widths to be placed on the easel and the angle at which the object rests on the easel is not adjustable. Of the easel designs that incorporate a shelf for an object to rest on, allowing objects of varying widths to be placed on it, many allow the easel to be collapsed for portability reasons. U.S. Pat. No. 7,334,768 to Lum collapses but does not collapse completely flat. The design also uses a number of parts including hinges to connect the parts of the easel together. Another easel design, U.S. Pat. No. 2,591,170 to Levinson, also has multiple parts including pin hinges that hold the structural parts together. Because both of these designs have multiple parts, the complexity and cost of manufacturing is increased.

Of those easel designs that are made from one piece of material, few are both collapsible and adjustable. One common design type is based on a V-shaped structure. U.S. Pat. No. 7,000,882 to Snuffer and U.S. Pat. No. 5,388,798 to Glick are examples of the V-shaped design. Although these easels are adjustable, the angle of adjustability is narrow. Also, when these easels are collapsed, their profiles are jagged making them less portable. Another type of easel design uses a triangular shape structure. U.S. Pat. No. 7,178,778 to Lee and U.S. Pat. No. 6,270,049 to Olvey are both examples of this type of design. They are adjustable by partially folding the base of the easel. But there are only two adjustment settings. U.S. Pat. No. 4,105,182 to Jacobson, another triangular design, comprises a single strip of material in the form of a triangle. It utilizes a pair of slits on one end of a strip through which the other end of the strip goes in one slit and out the other to form an upside down V-shaped shelf. Although collapsible, the easel must be disassembled beforehand. Another one-piece design, U.S. Pat. No. 1,976,421 to Traeger, is not adjustable and needs to be disassembled before folding up. U.S. Pat. No. 7,219,871 to Hecker and U.S. Pat. No. 5,755,423 to Michela are examples of an origami-like non-adjustable easel design. Michela's easel includes parts that need to be glued together, complicating the manufacturing process. U.S. Pat. No. 1,470,159 to Gibson, proposed an M-shaped easel design but it lacks stability.

Smart phones are increasing in popularity. They feature a screen on which may be displayed various forms of information including videos, movies and e-books. To view the screen ergonomically, the smart phone must be either held or propped up by some means so that a proper viewing angle may be achieved. Many smart phones have a curved base and would thus not sit stably on the prior art easels previously discussed because none of them incorporate a cradle-shaped shelf top to accommodate their curved base.

### BRIEF SUMMARY OF INVENTION

This invention describes an easel for holding objects and whose profile resembles an asymmetrical figure eight curve. The invention can be constructed from a single thin strip of planar material. The shelf top and backrest of the easel can be concave shaped allowing objects, such as smart phones, which may have curved bases or backs, to sit stably on the easel. The angle at which the object rests on the easel is adjustable and the easel collapses flat for portability, storage and packaging purposes.

### Benefits and Advantages:

The objects and advantages of the present invention are:

a) The easel's backrest angle may be easily adjusted for an optimal viewing angle of display objects resting on the easel.

b) The easel may be easily collapsed, without any need of disassembly beforehand, into a compact and thin configuration for purposes of portability, storage, and packaging.

c) The easel is a single thin strip of material reducing the cost of manufacturing.

d) The shelf top and backrest of the easel are concave shaped allowing objects, including smart phones, which may have curved bases and curved backs to sit stably on the easel.

e) The easel has features so that electronic devices that have the charging port located on their base may be charged while resting on the easel.

f) The easel, in collapsed form, may be used as a protective case for a smart phone or other object.

g) The shelf top of the easel that holds the display object is raised off the surface on which the easel rests, providing protection against liquid spills that could damage the display object.

h) Graphics including designs and company logos as well as stickers, may be displayed on the shelf front and the backrest surfaces of the easel for purposes of advertising and personalization.

### BRIEF DESCRIPTION OF THE SEVERAL VIEWS OF THE DRAWING

FIG. 1A shows a perspective view of the easel.

FIG. 1B shows a profile view of the small and large loops of the easel.

FIG. 2A shows a pre-assembled view of the easel as a thin strip of material with straight bends.

FIG. 2B shows a pre-assembled view of the easel as a thin strip of material with some of the bends being curved.

FIG. 3 shows a view of the shelf or small loop of the figure eight-shaped easel.

FIGS. 4A and 4B show insertion of the head of the belt into a slot on the back of the easel.

FIGS. 5A and 5B show a belt and buckle mechanism that fastens the belt to the back of the easel.

FIGS. 6A and 6B show a finger and a charging plug being inserted through an opening on the back of the easel.

FIG. 7A to FIG. 7C shows alternate buckle mechanisms that use friction and pressure instead of protrusions engaged with holes to fasten the belt and shelf.

FIG. 8 shows tabs and openings in the front of the easel through which a charging plug of an electronic device is inserted.

FIGS. 9A to 9C show three configurations of one embodiment of the easel.

FIGS. 10A to 10C show three configurations of an alternate embodiment of the easel in which the belt is inserted through a slot on the back and then through a slot on the base.

FIGS. 11A to 11C show three configurations of an alternate embodiment of the easel in which the belt is inserted through two slots on the back, a slot on the base and finally through a slot on a flap on the back of the shelf.

FIGS. 12A to 12C show an alternate embodiment of the easel in which all or portions of the easel of an embodiment previously disclosed, with some modifications, is turned upside down.

FIG. 13 shows a snap that fastens the back and the base of the easel together when the easel is collapsed.

FIG. 14 shows the easel in the collapsed configuration being used as a protective case for a smart phone.

### DETAILED DESCRIPTION OF THE INVENTION

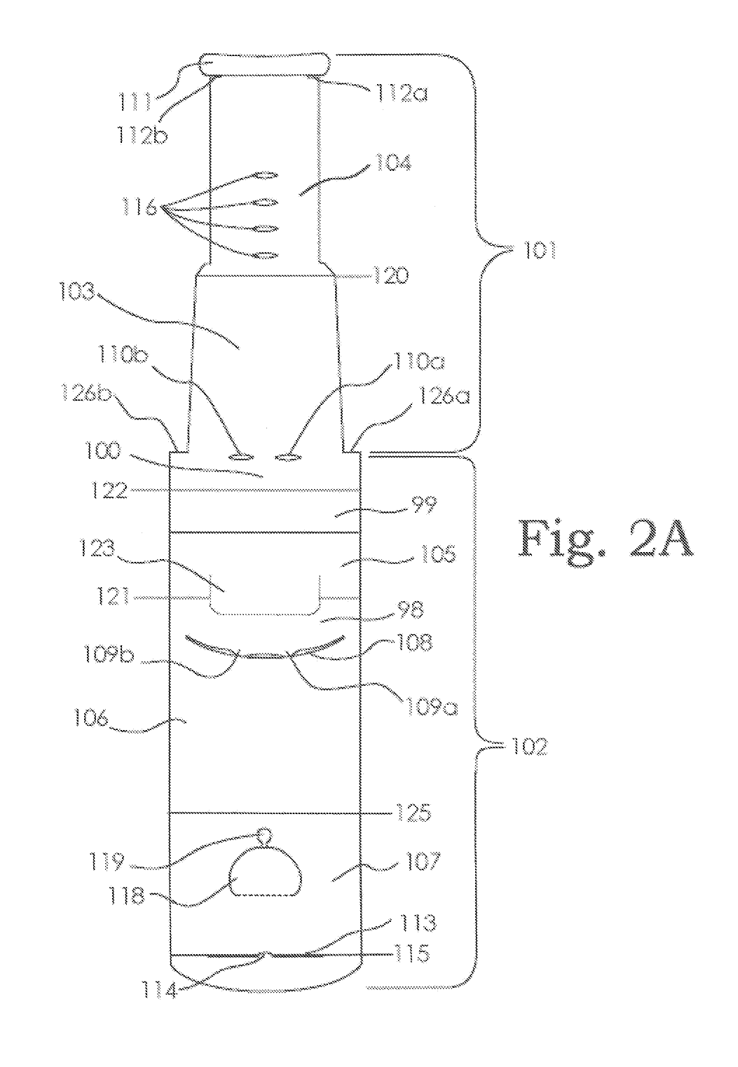

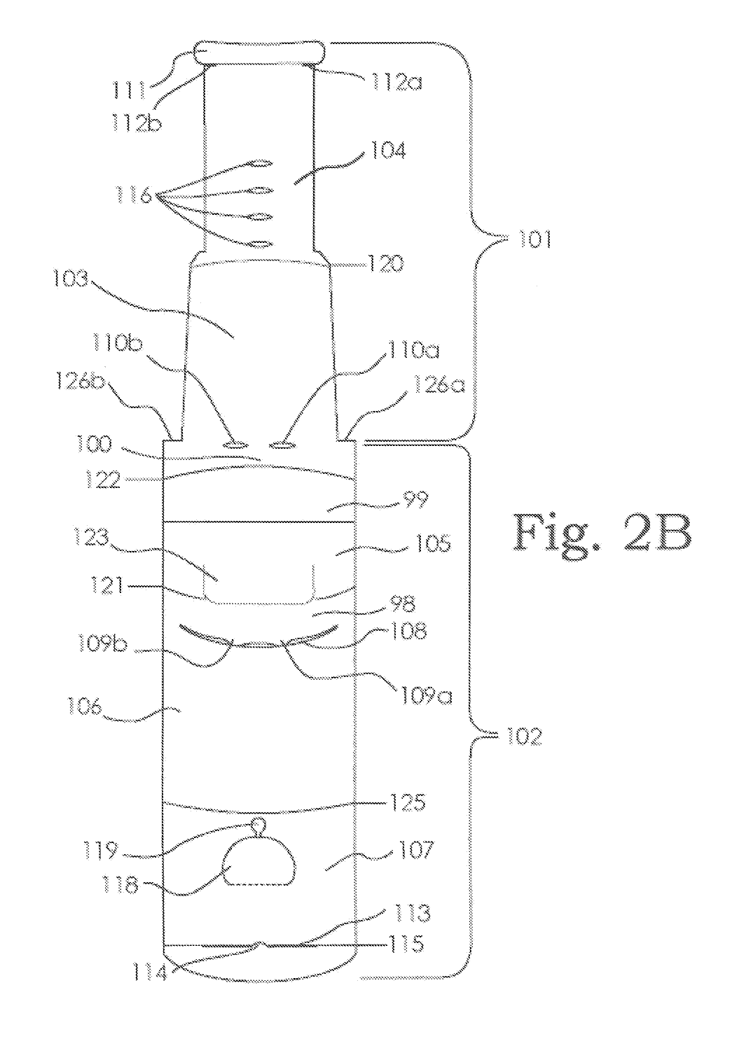

As seen in FIG. 2A, an embodiment could have a single thin strip of material. This strip may have a narrow section 101 and a wide section 102, which meet at a pair of stops 126a and 126b. Narrow section 101 may have a backrest 103 and a belt 104. Wide section 102 has a shelf top 98, a shelf front 105, a shelf base 99, a shelf back 100, a base 106, and a back 107.

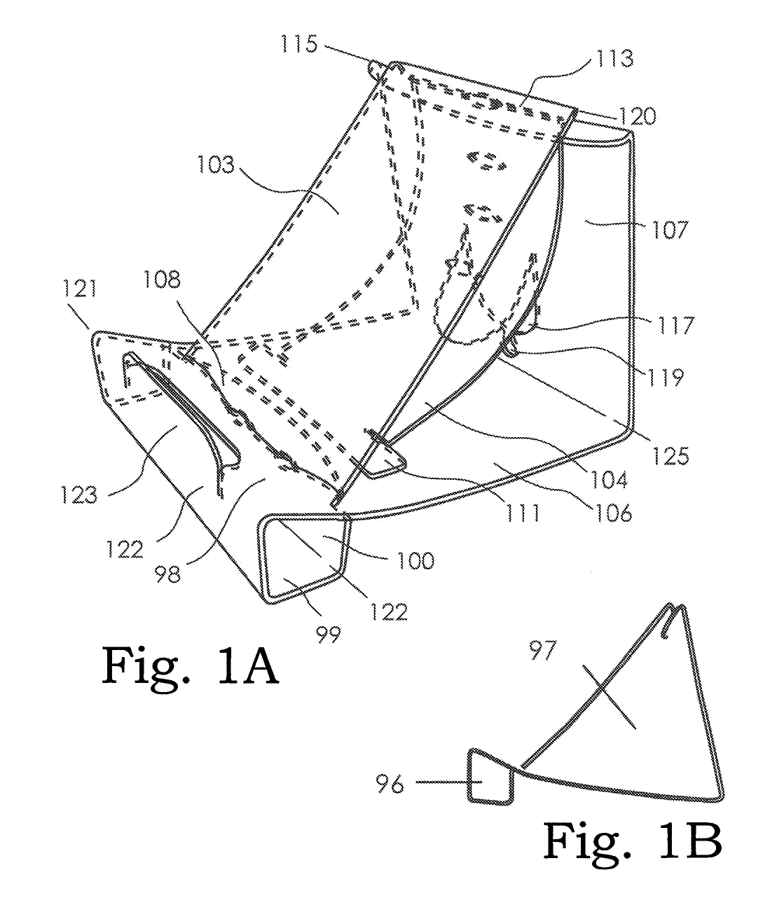

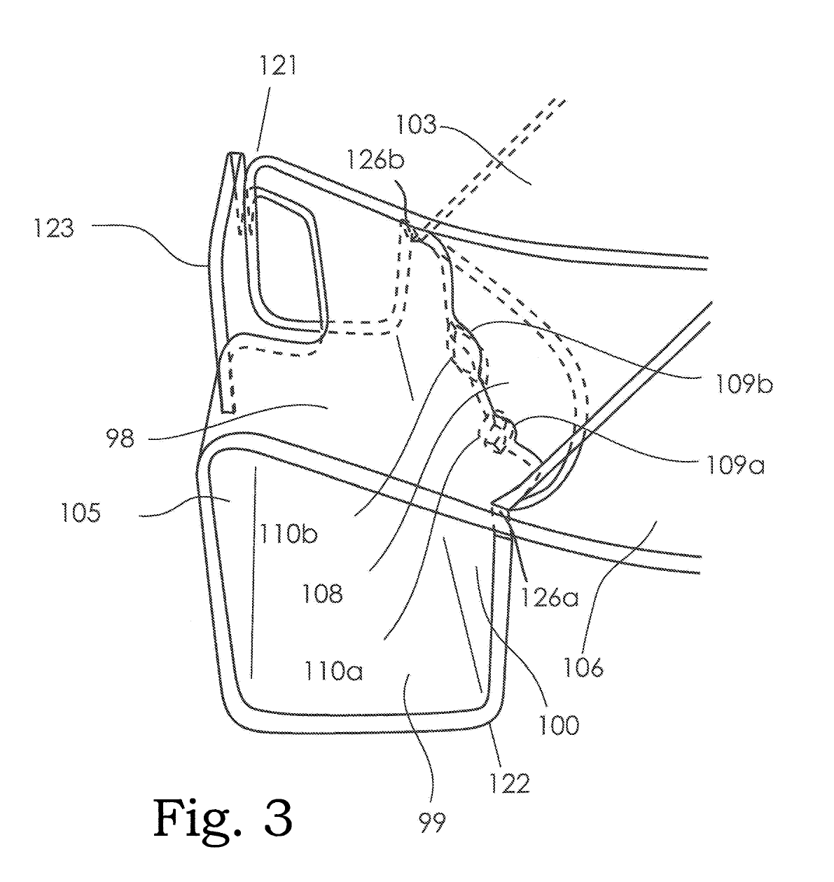

The easel may be assembled by first inserting a head 111 of belt 104 into a midsection slot 108 and then pulling it to form a small loop or shelf 96 of the figure eight-shaped easel as seen in FIG. 1B. FIG. 3 shows that the shelf can be buckled by inserting a pair of protrusions 109a and 109b of midsection slot 108 into a pair of holes 110a and 110b at the top of shelf back 100. The length of the perimeter of the shelf can be prevented from shortening by stops 126a and 126b. When the easel is in use, a concave shaped depression or well may be formed on shelf top 98 close to backrest 103 because holes 110a and 110b are below the height of stops 126a and 126b providing a stable support for objects with curved bases such as a smart phone.

Midsection slot 108 may be curved causing backrest 103, inserted through the midsection slot, to flex in its shorter dimension, increasing the rigidity of the backrest and providing a stable support for objects with curved backs. The easel has at least one closely adjacent and parallel bend 121 on either side of a tab 123 where shelf top 98 and shelf front 105 meet. There can be at least one closely adjacent and parallel bend 122 where shelf back 100 and shelf base 99 meet. As seen in FIG. 1A, there may be at least one closely adjacent and parallel bend 120 at the top of backrest 103. There can be at least one closely adjacent and parallel bend 125 where base 106 and back 107 meet.

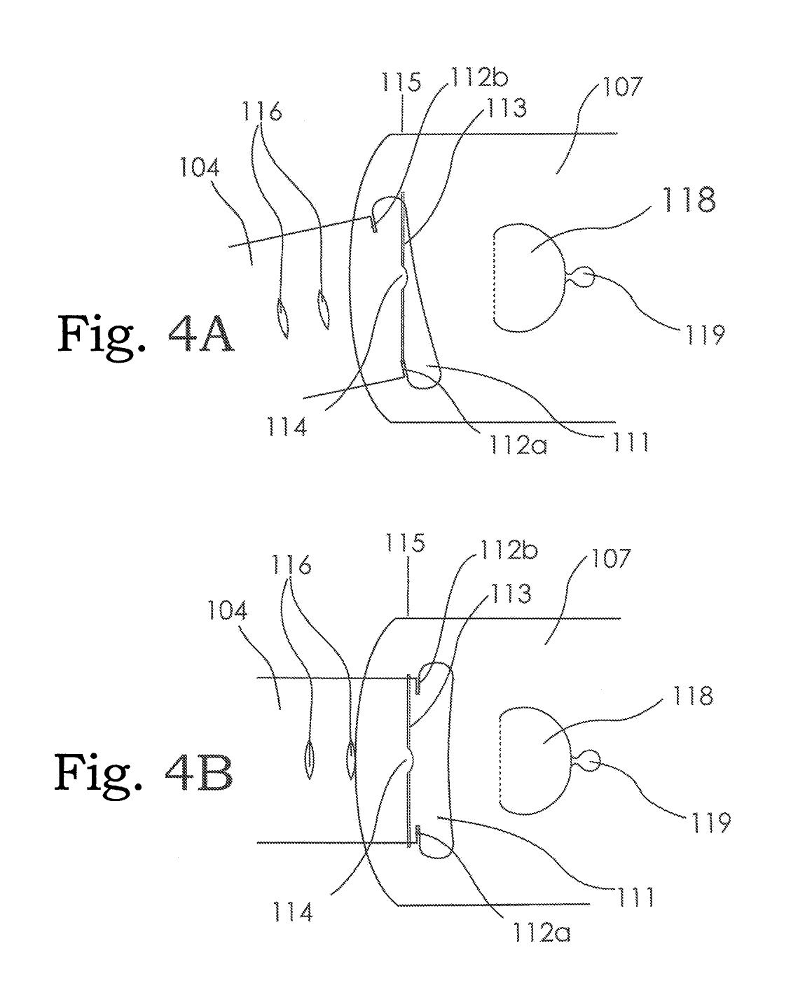

FIG. 4A illustrates head 111 of belt 104 being inserted from the outside of the easel into a back slot 113 near the end of back 107 so that the head of the belt moves into the interior of a large loop 97, shown in FIG. 1B. As seen in FIG. 4A, the insertion of belt 104 into back slot 113 may be accomplished by doing the following steps.

a) Insert one side of head 111 into back slot 113.

b) Push belt 104 sideways so that a slit 112a or a slit 112b, depending on which side of the head was inserted, fits into back slot 113.

c) Insert the other side of head 111 into the back slot, as seen in FIG. 4B.

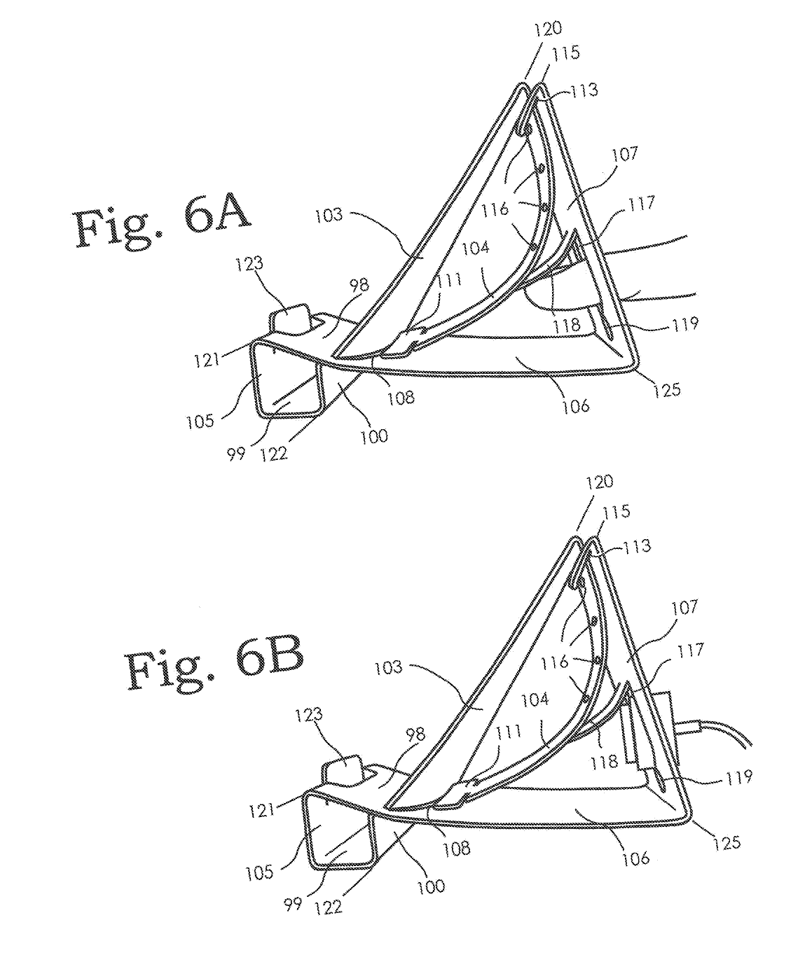

FIG. 6A shows that in order for belt 104 to be inserted into back slot 113 as far as the point where the belt widens near bend 120, head 111 of the belt must move towards the front of the easel, while being pushed through the back slot. Otherwise, the belt may move parallel to back 107 and stop prematurely against base 106 near bend 125. An opening 117, large enough for a person to insert their finger, is located on the back. Opening 117 can be covered by a flap 118, which may be hinged at the top of the opening. The flap may be partially bent towards the front of the easel. FIG. 3 illustrates tab 123 facing upwards at the top of shelf front 105 of the easel.

### Operation of Invention:

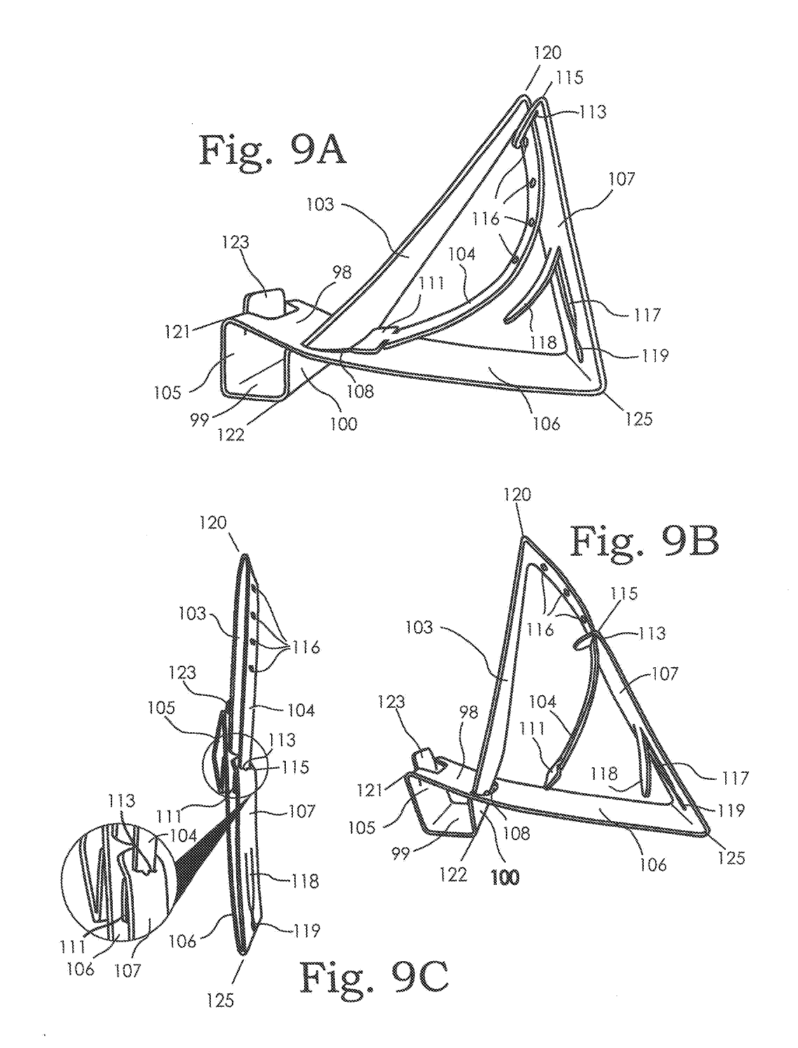

FIG. 9C illustrates the easel in the collapsed configuration. In order to expand the easel when it is in the collapsed configuration, the following two steps may be performed.

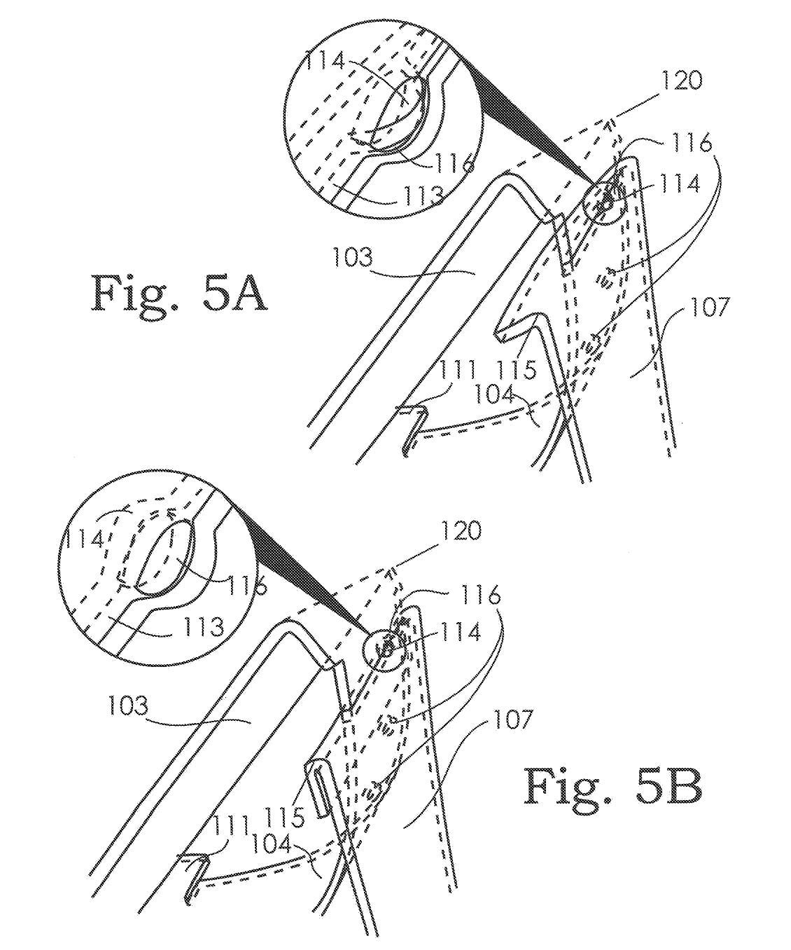

a) Push bend 120 and bend 125 together causing belt 104 to slide through back slot 113, as seen in FIG. 9A. As seen in FIG. 5A, a protrusion 114 in the back slot engages with one of a set of holes 116 on belt 104 when the end of back 107 at bend 115 is bent at approximately a right angle. b) Push shelf top 98 and shelf base 99, as shown in FIG. 3, closer together causing protrusions 109a and 109b in midsection slot 108 to engage with holes 110a and 110b. This fastens the shelf and, because stops 126a and 126b are higher than holes 110a and 110b, with the easel in use, a concave shaped depression may be formed on the shelf top allowing display objects with curved bases, such as some smart phones, to sit stably on the easel. Tab 123 prevents the base of the display object from sliding forward.

FIG. 5B shows that by bending and holding the end of back 107 at bend 115 at approximately 180 degrees, protrusion 114 disengages with one of holes 116 allowing belt 104 to slide in and out of back slot 113 freely. To stop the belt from sliding through the back slot, release the end of the back so that the bend angle at bend 115 returns to approximately a right angle and protrusion 114 engages with one of holes 116. If enough force is applied when sliding belt 104 through back slot 113, the end of the back may remain bent at approximately a right angle at bend 115 because the pushing or pulling force will overcome the force keeping the protrusion in the hole allowing the belt to slide through the back slot, albeit with some resistance.

The lower the hole of holes 116 in belt 104 that protrusion 114 engages with, the more vertical the display object's resting angle will be, as seen in FIG. 9B. Conversely, as seen in FIG. 9A, the higher the hole engaged by the protrusion, the more inclined the display object's resting angle will be. In order to engage protrusion 114 with the uppermost holes, head 111 of belt 104 can be pushed towards the front of the easel to accommodate the belt's length. As seen in FIG. 6A, flap 118 can be bent towards the front of the easel which automatically guides head 111 of belt 104 towards midsection slot 108 when belt 104 is pushed through back slot 113. The belt may also be manually guided towards the front of the easel by inserting a finger through opening 117 and pushing on the belt.

In order to collapse the easel when it is in the expanded configuration, the following two steps may be performed:

a) Pull belt 104 through back slot 113 until head 111 reaches back slot 113 and stops, as shown in FIG. 4B.

b) Press front 105 and the end of back 107 together, as seen in FIG. 9B.

When the easel is in the collapsed position, an object, such as a smart phone, may be inserted into the space between base 106, belt 104, back 107, and backrest 103. By inserting an object, such as a smart phone, into this space, the easel can function as a protective case for the object, as shown in FIG. 14. Strap 133 can encircle the easel so that the object does not slip out through either side of the easel. This strap may be part of the single strip of material such as horizontal wings that extend out from both sides of shelf front 105, shelf base 99, shelf top 98, or shelf back 100, wrap around and fasten in the back of the easel with a hook-and-loop fastener or snap. Alternatively, the strap may have horizontal wings that extend out from both sides of back 107, wrap around and fasten in the front of the easel with a hook-and-loop fastener or snap. The strap may also be a separate strip of material that can be fastened to the easel by being weaved through slits in the easel or by way of a hook-and-loop fastener or snap or held in place with the strap being made of elastic material.

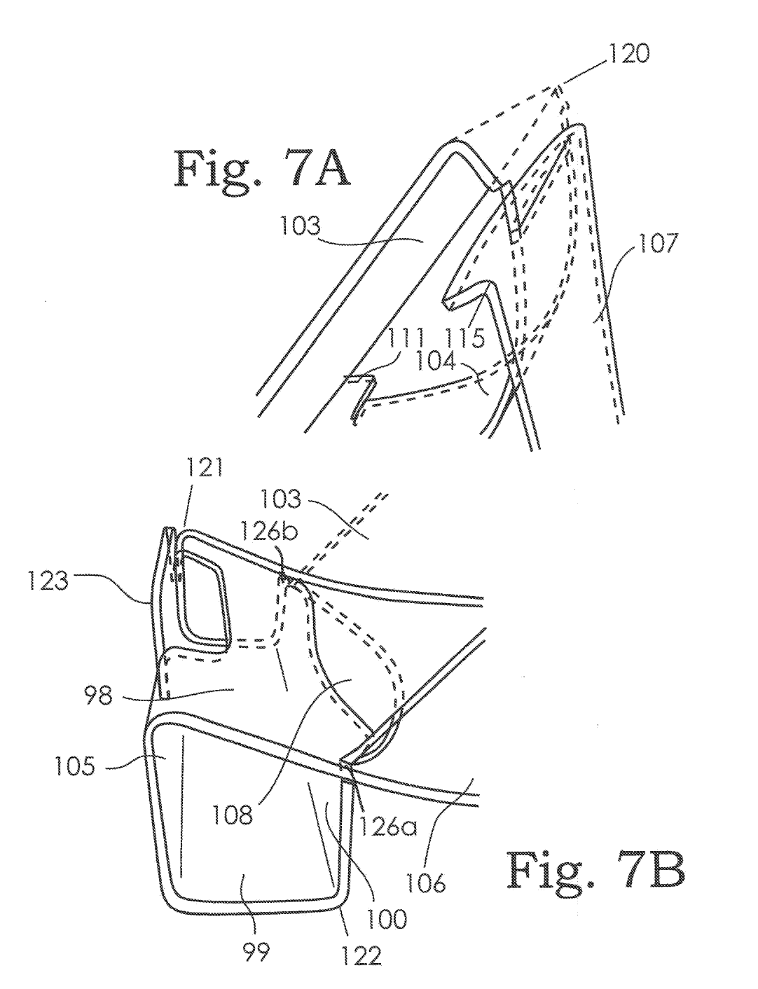

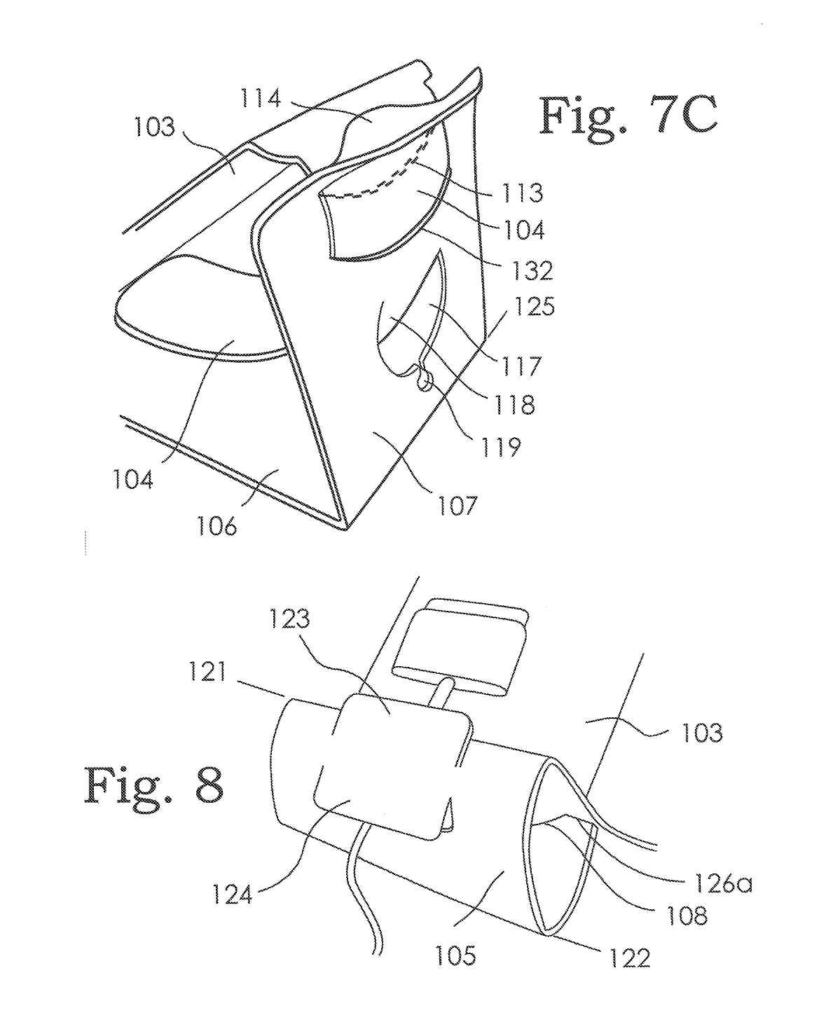

As seen in FIG. 6B, opening 117 may be wide enough to permit a charging plug for an electronic device to be inserted through the opening. FIG. 7C shows a small hole 119 connected to opening 117 by an open channel. In order to keep the charging cord of an electronic device coupled to the easel, the charging plug may be inserted through opening 117 and the cord may be moved into hole 119 by way of the open channel between them.

In an alternate embodiment of the invention, there may be a tab 124 on front, as illustrated in FIG. 8. If an electronic device resting on the easel has a charging port on its base, the charging plug may be inserted through the opening created by tab 124, followed by inserting the plug through the opening created by tab 123, and finally inserting the plug into the charging port of the electronic device.

In an alternate embodiment of the invention, the shelf buckle mechanism does not use protrusions 109a, 109b nor holes 110a, 110b, seen in FIG. 3, to hold the depressed concave shape of shelf top 98 because the depressed shape may be automatically formed when pushing the shelf top downwards, as seen in FIG. 7B. The pushed down portion of the shelf top flexes in the shorter dimension of the strip, and exerts pressure against backrest 103 in its attempt to return to being coplanar with the adjacent material of the shelf top.

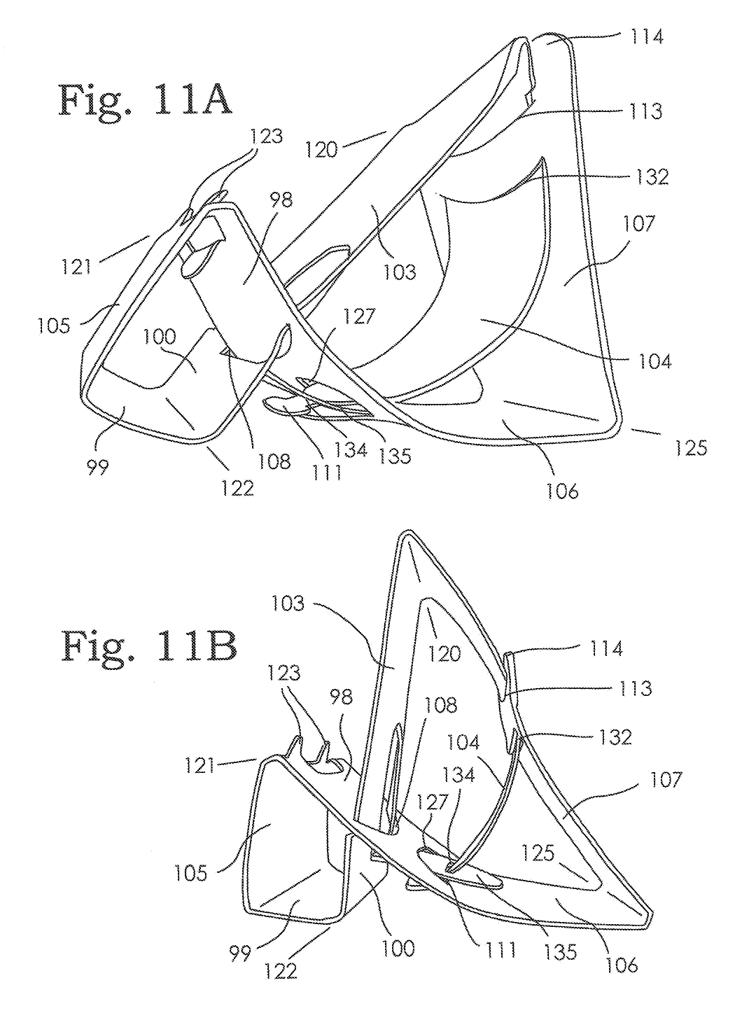

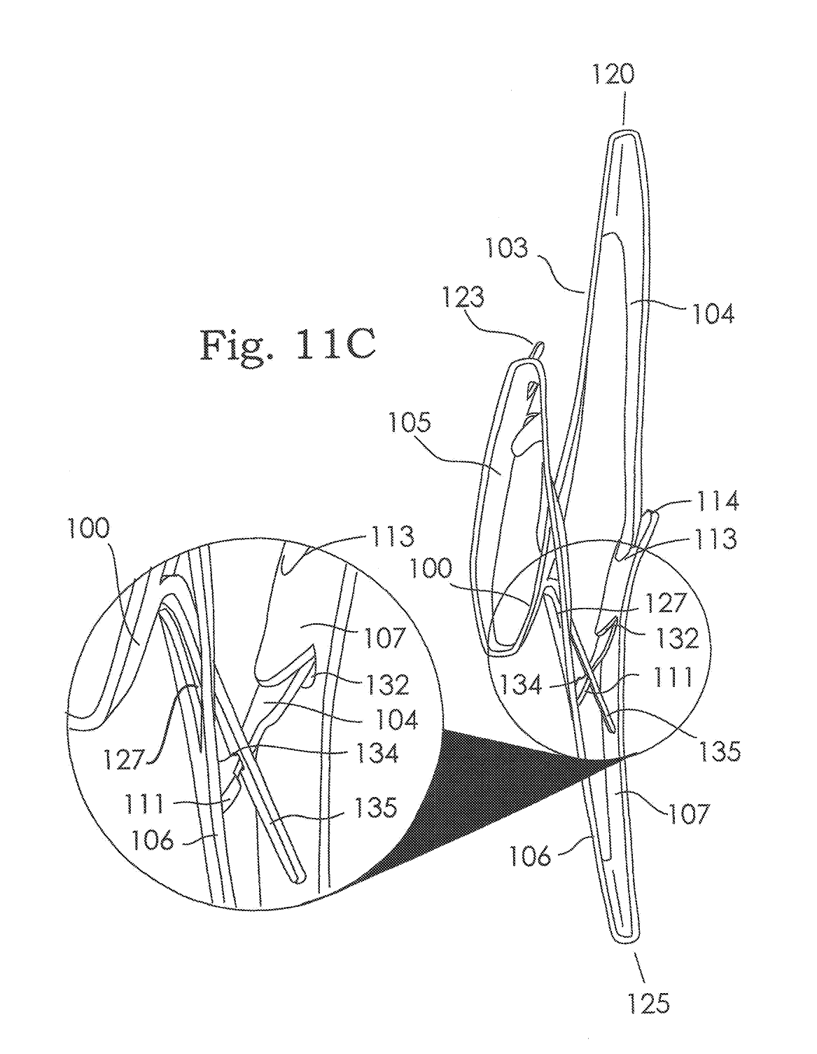

In an alternate embodiment of the invention, the back buckle mechanism does not need protrusion 114, nor holes 116, seen in FIG. 5A, to hold the belt firmly in place while inserted through back slot 113. Instead, as seen in FIG. 7C and FIGS. 11A through 11C, there may be an additional slot 132 through which the belt can be inserted. Back slot 113 and additional slot 132 can be curved downwards. Belt 104 may be inserted through back slot 113 from the inside out and then inserted through additional slot 132 from the outside in so that the end of the belt moves into the interior of the easel. By going through two slots, the friction on the belt can be increased. By pushing the convex portion of the end of back 107 above back slot 113 upwards, the pushed up portion of the back flexes and exerts pressure against belt 104 in its attempt to return to being coplanar with the adjacent material of back 107. This increases the friction on the belt to lock it in place.

In an alternate embodiment of the invention, other fastening is used instead of a belt and buckle mechanism to adjust the angle of the backrest. This may include, but is not limited to, a series of snaps or the use of a strip of hook-and-loop fastener.

In an alternate embodiment of the invention, the belt and back are fastened together either permanently but not limited to, glue and staples, or temporarily fastened with but not limited to, a snap or a hook-and-loop fastener. This fastening allows only one backrest angle and thus the easel is not adjustable.

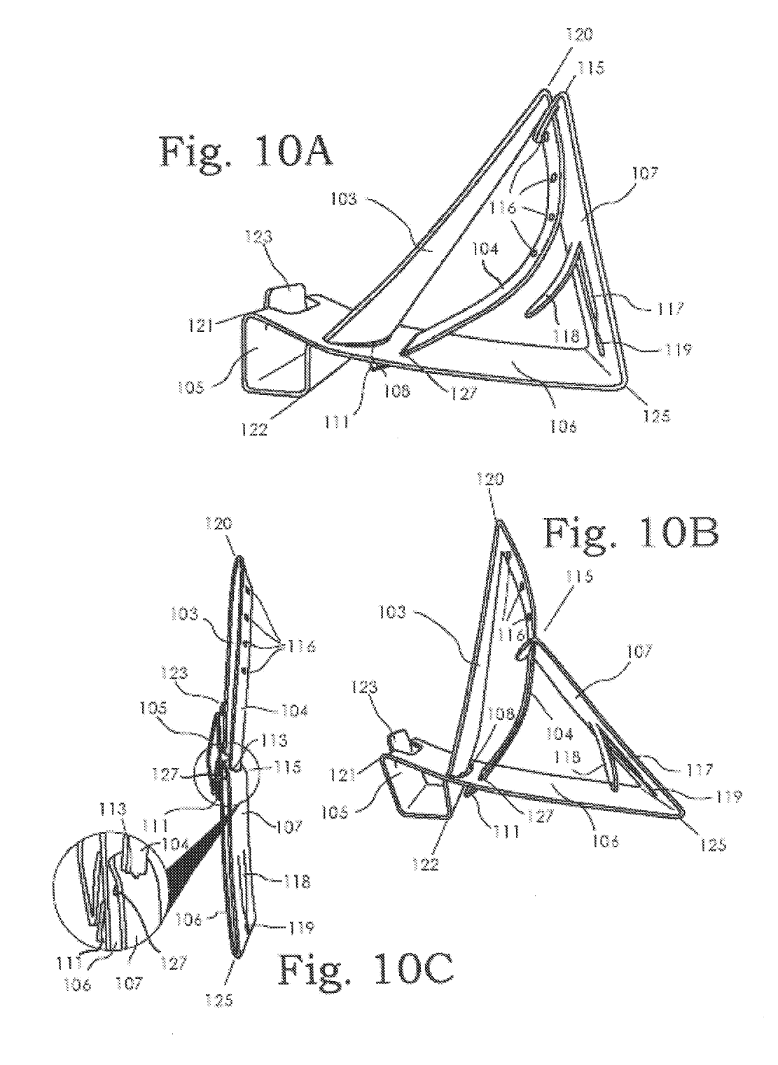

In an alternate embodiment of the invention, FIG. 10A shows head 111 of belt 104 inserted permanently into a base slot 127 on base 106 after being inserted through back slot 113. This embodiment functions in the same manner as an embodiment previously disclosed, except that, as seen in FIGS. 10A and 10B, in order to adjust the backrest angle, back 107 must be rotated about bend 125. When the easel is in the collapsed configuration, as seen in FIG. 10C, head 111 may be held inside base slot 127 keeping the easel flat when collapsed as well as making the process of expanding the easel easier.

In an alternate embodiment of the invention, FIG. 11A through FIG. 11C show head 111 of belt 104 inserted permanently into a slot 134 on a flap 135 on shelf back 100. Flap 135 may be inserted through base slot 127 on base 106. This embodiment functions in the same manner as an embodiment previously disclosed, except that the process of expanding the easel can be easier because there is no need to push the head 111 of belt 104 forward because it is permanently fastened inside of slot 134 on flap 135 on shelf back 100.

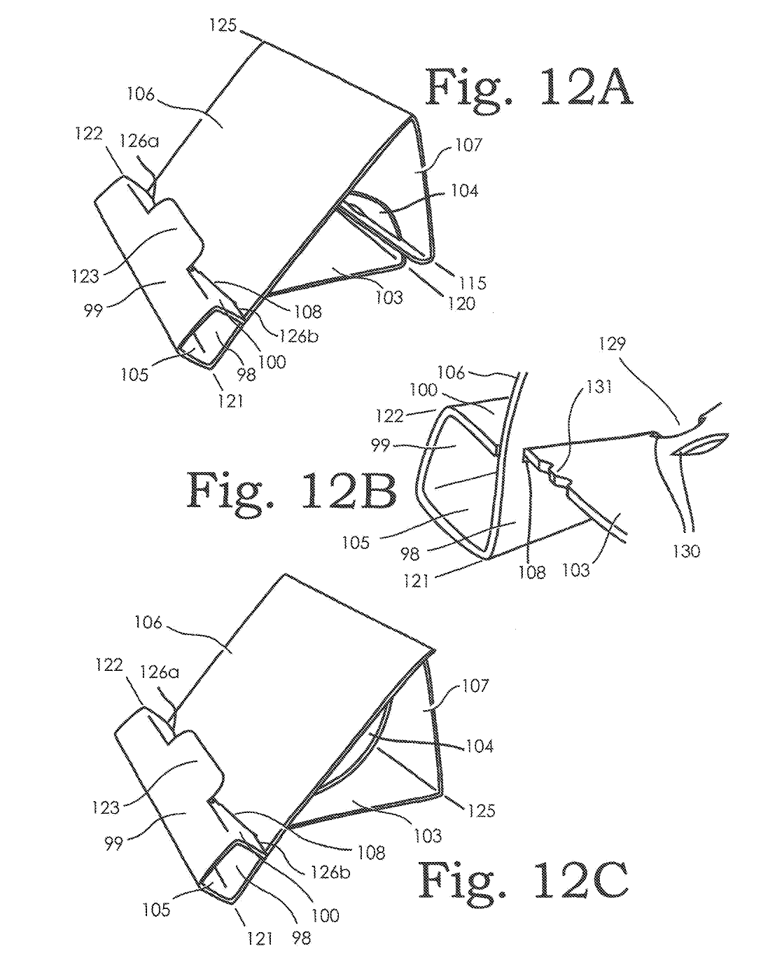

In an alternate embodiment of the invention, as shown in FIG. 12A, the easel can be turned upside down. Base 106 now functions as the backrest in this embodiment. Midsection slot 108 may be curved in the opposite direction creating a concave shaped depression on shelf back 100, acting as the shelf top, next to base 106, allowing display objects with curved bases, such as some smart phones, to sit stably on the easel. FIG. 12B shows that base 106, may be flexed in its shorter dimension similar to the backrest of an embodiment previously disclosed, by pushing the middle portion of base 106 immediately above midsection slot 108 towards the back of the easel so that a protrusion 129 in midsection slot 108 engages with one of a set of holes 130 on backrest 103, functioning as the base, while holding the sides of base 106 in place. Base 106 flexes as a result and the width of the midsection slot on base 106 becomes shorter locking into one of a set of notches 131 on both sides of backrest 103. With the base not flexed, midsection slot 108 can be wider, allowing backrest 103 to slide in and out of the midsection slot adjusting the distance between base 106 and tab 123, as seen in FIG. 12A. This allows the easel to accommodate display objects of various thicknesses.

In an alternate embodiment of the invention, as seen in FIG. 12C, the easel, excluding belt 104 and back 107, can be turned upside down. Base 106 now functions as the backrest in this embodiment. Midsection slot 108 can be curved in the opposite direction so that there is a concave shaped depression on shelf back 100, acting as the shelf top, next to base 106, allowing display objects with curved bases, such as some smart phones, to sit stably on the easel. FIG. 12B shows that base 106, may be flexed in its shorter dimension similar to the backrest of an embodiment previously disclosed, by pushing the middle portion of base 106 immediately above midsection slot 108 towards the back of the easel so that protrusion 129 in the midsection slot engages with one of holes 130 on backrest 103, functioning as the base, while holding the sides of base 106 in place. Base 106 flexes as a result and the width of the midsection slot on base 106 becomes shorter locking into one of notches 131 on both sides of backrest 103. With the base not flexed, midsection slot 108 can be wider, allowing backrest 103 to slide in and out of midsection slot 108 adjusting the distance between base 106 and tab 123, as seen in FIG. 12C. This allows the easel to accommodate display objects of various thicknesses. Belt 104 and back 107 are not turned upside down and function in an identical manner as in an embodiment previously disclosed, although they are required to be narrower than in an embodiment previously disclosed because back 107 must be narrow enough to fit through midsection slot 108 when the easel is constructed and belt 104 must fit through back slot 113.

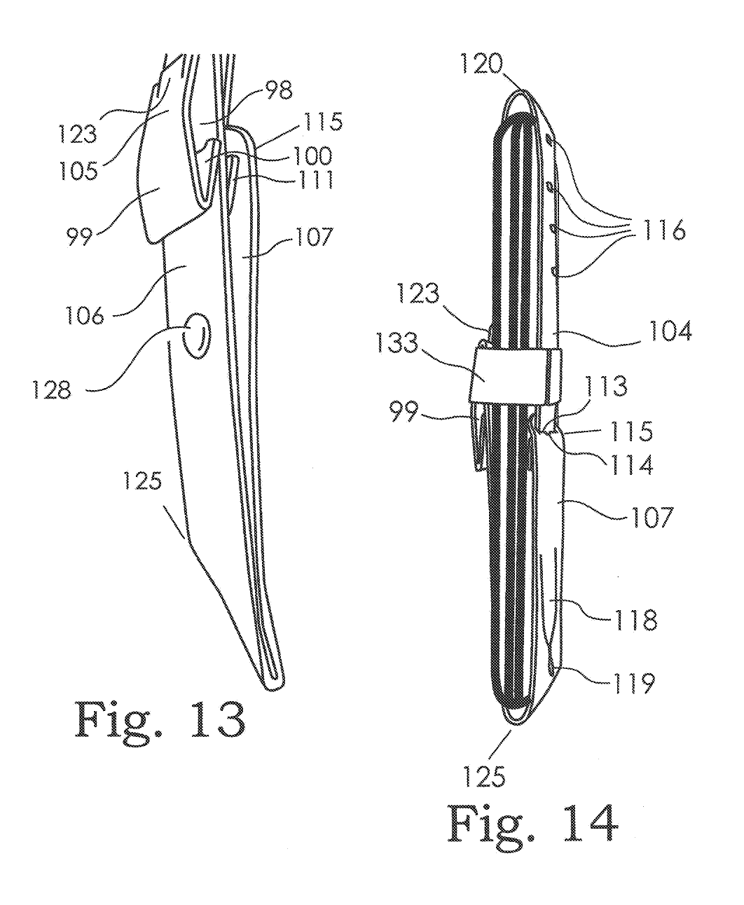

In an alternate embodiment of the invention, fastening may be used to keep the easel in a flat profile when in the collapsed configuration. Fastening may include, but is not limited to, snaps, hook-and-loop fasteners, and magnets. FIG. 13 shows one possible way of fastening; the use of a snap 128, located on base 106, whose receptacle is located on back 107.

In an alternate embodiment of the invention, as seen in FIG. 7A, belt 104 can be inserted through back slot 113 on back 107 and the belt may be held in place by the friction between the belt and the slot instead of using protrusion 114 engaged with one of holes 116, as seen in FIGS. 5A and 5B. This friction may be overcome when a person pushes or pulls the belt through the slot when adjusting or collapsing the easel.

In an alternate embodiment of the invention, at least one closely adjacent and parallel bend 120, 121, 122, and 125, as seen in FIG. 2B, can be curved. With curved bends, the easel will flex in its shorter dimension. If bend 120, for example, is curved, backrest 103 at bend 120 will flex in the same manner as it does at midsection slot 108 when the easel is bent at bend 120, providing additional rigidity to the backrest. If bends 120, 121, 122, and 125, are all curved, as shown in FIG. 2B, the easel, in its collapsed configuration, flexes as a whole in its shorter dimension. This may be desired ergonomically, to fit the collapsed easel against a person's body when carried in a pocket, or more comfortable to hold when held in the palm of a person's hand. It may also aid in keeping the easel in its collapsed configuration.

In an alternate embodiment of the invention, the easel can be formed as one molded piece with large loop 97, as seen in FIG. 1B, open at the back and the two open ends of the back functioning in the same manner as one of the embodiments previously discussed.

In an alternate embodiment of the invention, the easel can be formed as one molded piece with no open back. The easel may still be collapsible and adjustable provided bends exist on the top and bottom of both the small and large loops as well as an additional bend near the middle of the back of the large loop. By compressing the front and back of the easel together, the easel will collapse. By pressing the bends on the top and bottom together, the backrest will incline.

### Conclusions, Ramifications, and Scope:

While our description contains much specificity, these should not be construed as limitations on the scope of the invention, but rather as an exemplification of one preferred and some alternate embodiments thereof Many other variations are possible. For example, non-slip pads such as but not limited to rubber or silicone may be affixed to the bottom of the easel to prevent the easel from sliding on the surface on which it is resting. Non-slip pads such as but not limited to rubber or silicone may also be affixed to the shelf top of the easel to prevent the display object from slipping while resting on the shelf The edges and interior of the easel may be cut to create abstract or figurative shapes for decorative purposes. The easel may be made larger to hold objects such as books or papers. It may also be made smaller to hold objects such as business cards.

Accordingly, the scope of the invention should be determined not by the embodiments illustrated, but by the appended claims and their legal equivalents.

We claim:

1. An easel for holding objects comprising:
a first loop creating a shelf supporting the base of displayed object;
a second loop creating a backrest supporting the back of displayed object, wherein said first loop and said second loop are conjoined.

2. The easel for holding objects of claim 1, wherein said first loop further comprises a shelf top, a shelf front, a shelf base, and a shelf back.

3. The easel for holding objects of claim 1, wherein said second loop further comprises a backrest, a base and a back.

4. The easel for holding objects of claim 1, wherein there is at least one fold in said first loop and at least one fold in said second loop allowing said easel the ability to collapse.

5. The easel for holding objects of claim 1, wherein at least one opening is made in said shelf through which an electronic device's charging plug may be inserted.

6. The easel for holding objects of claim 3, wherein said back of said second loop comprises two strips fixedly fastened.

7. The easel for holding objects of claim 3, wherein said back of said second loop comprises two overlapping strips adjustably fastened.

8. The easel for holding objects of claim 3, wherein there is at least one fold where said backrest and one of said overlapping strips meet.

9. The easel for holding objects of claim 4, wherein there is at least one fold where said back and said base meet.

10. The easel for holding objects of claim 8, wherein said overlapping strip connected to said backrest goes through a base slot.

11. The easel for holding objects of claim 10, wherein said overlapping strip is inserted through a flap on said shelf back.

12. An easel made from a planar strip of material for holding display objects comprising:
a narrow section;
a wide section; and
a pair of stops where the narrow section and wide section meet.

13. The easel for holding objects of claim 12, wherein said narrow section further comprises a backrest and a belt.

14. The easel for holding objects of claim 13, wherein there is at least one fold where said backrest and said belt meet.

15. The easel for holding objects of claim 12, wherein said wide section further comprises a shelf top, a shelf front, a shelf base, a shelf back, a base, and a back.

16. The easel for holding objects of claim 15, wherein there is at least one fold where said back and said base meet.

17. The easel for holding objects of claim 12, wherein there is at least one fold in said narrow section and at least one fold in said wide section allowing the easel to collapse flat.

18. The easel for holding objects of claim 15, wherein said shelf top and backrest of the easel are concave shaped allowing display objects to sit stably on the easel.

19. The easel for holding objects of claim 12, wherein the angle at which the display object rests on the easel is adjustable.

21. A method of collapsing an easel while in the expanded configuration, the steps comprising:
pulling the top of a large loop and the bottom of said large loop apart; and
pressing a shelf front and a back together to form a flattened profile.

22. A method of assembling an easel from a planar strip of material, the steps comprising:
inserting a narrow section through a midsection slot;
pulling said narrow section until the stops reach said midsection; and
inserting said narrow section through at least one back slot.

23. A method as of claim 22, wherein said method of assembling further comprises:
inserting said narrow section through a base slot; and
inserting said narrow section through a slot on a flap on a shelf back.
